(19) United States
(12) Patent Application Publication
(10) Pub. No.: US 2010/0049435 A1
(43) Pub. Date: Feb. 25, 2010

(54) Communication Routing Apparatus And Method Via Navigation System

(76) Inventors: Hsia-Hsin Li, Hsinchu (TW); Chong-Yie Chang, Changhua (TW)

Correspondence Address: LIN & ASSOCIATES INTELLECTUAL PROPERTY, INC., P.O. BOX 2339, SARATOGA, CA, 95070-0339, US

(21) Appl. No.: 12/194,541

(22) Filed: Aug. 20, 2008

(51) Int. Cl. G01C 21/30

(52) U.S. Cl. 701/210; 701/209

(57) ABSTRACT

Disclosed is a communication routing apparatus and method via navigation system, which is applicable to mobile networks. The apparatus comprises a routing protocol mechanism and a navigation module having map information and a navigation path calculating unit therein. The routing protocol mechanism inputs the location information of a source and a destination to the navigation path calculating unit. Through the map information, the navigation path calculating unit suggests a communication route between the mobile nodes from the source to the destination. With the help of the communication route, the routing protocol mechanism handles the route discovery message, the route reply message and the route error message from the source to the destination.

### FIELD OF THE INVENTION

The present invention generally relates to a communication routing apparatus and method via navigation system, applicable to mobile networks.

### BACKGROUND OF THE INVENTION

Mobile network consists of mobile nodes moving constantly, which results in a frequent change of communication routes. Nowadays many mobile devices have built-in maps and navigation systems, such as Global Positioning System (GPS).

The Mobile nodes, such as mobile vehicles, which usually carry wireless communication devices for sending or receiving control messages and data across the wireless medium. The mobile vehicles are usually moving at different speeds or in different directions, or toward possibly different destinations. The direct communication between the source and the receiver is usually impossible due to the nature of the vehicle movement, and the short transmission range of the wireless communication device on board. To help disseminate messages, mobile vehicles joined together to form a network. This was often referred to as vehicular ad-hoc network (VANET).

The mobile ad-hoc network routing may have many applications. One example is a party of several vacation buses traveling together, which heads toward the same scenic destination, and needs communication periodically to check whether all of the vehicles are going well or not. Another example is a group of military vehicles on the same mission having needs to communicate with each other to update the latest information on the battlefield.

In mobile networks, many routing protocols have been presented. They may be roughly divided into two categories, i.e. table-driven protocols and on-demand routing protocols.

In the table-driven routing protocols, nodes constantly broadcast and exchange routing messages to nearby nodes, so that each node's routing table records the routes to the entire network. When a node needs to send a data message, it may know the route from its routing table. The data message may be sent immediately because the routing table is routinely maintained. However, the effort in maintaining the routing table is huge. Due to the constant changing topology, routing table is updated constantly and the control messages must be transmitted periodically. The control messages even occupy available bandwidth during heavy data transmission.

The on-demand routing protocols may reduce the overhead of maintaining the huge routing table, by sending route discovery messages to request the routing information to the receiver node only when the need to send data arises. A typical example of an on-demand protocol is the Dynamic Source Routing (DSR) protocol. In DSR protocol, when a source node wants to send data to a destination node, it first generates a route discovery message to the nearby nodes, which helps disseminate the route discovery messages to their neighboring nodes.

Each node that helps disseminating a route discovery message adds its node information to the header of the route discovery message, forms the route discovery path information. When the destination node finally picks up the route discovery messages, it selects a preferred route based on some algorithm. The algorithm is usually the weighted shortest path algorithm. The destination node sends a route reply message back to the source node to acknowledge the selected route information.

The route reply message was sent back through the route reply path, which is the reverse path of this particular route discovery path. Each node on the route reply path updates its routing table, and forwards the route reply message back through the path. When the route reply message was finally received by the source node, it then updates its routing table and sends the data. The first route discovery message that reached the destination node is usually the path with the least hop count. This path will be chosen by the destination node as the route path, and the destination node sends a route reply message reversely along that selected path back to the source node.

FIG. 1 and FIG. 2 illustrate how the route discovery and route reply messages are disseminated in the DSR protocol, respectively. It may be seen from FIG. 1 that how a route discovery message is disseminated from source node 1 to destination node 9, when source node 1 wants to send data to destination node 9. For example, this may be achieved from the path 1→2→6 to destination node 9, or from the path 1→2→4→7 to destination node 9, or from the path 1→3→5→8 to destination node 9. The path from the path 1→2→6 to destination node 9 has the least hop count.

Accordingly, it may be seen from FIG. 2 that destination node 9 selects the path 1→2→6→9 as the route path, and sends a route reply message reversely along the path 1→2→6→9 back to source node 1.

When the routing information is no longer correct due to nodes' moving, the data message may not be delivered successfully. In such a case, the intermediate node which detects the route change issues a route error message back to the source node. The route error message is sent reversely along the route path, and each node along the path removes the obsolete route entry. When the source node receives the route error message, it may then reinitiate the route discovery message. After the route discovery is reinitiated, data may be transmitted. In this manner, the route information is discovered on-demand but not up to date. Therefore, data cannot be transmitted immediately.

With the help of location information, Location Aided Routing (LAR) protocol significantly reduces the number of routing messages. In LAR, the source node sends the route discovery message together with the location information of the source and the destination nodes. Here it is assumed that the location of the destination node at a particular time is known, and this information may be obtained if the destination node is contacted before. If this information is not available at the initial time, it may be obtained by flooding the route discovery message as discussed in previous on-demand routing protocol. FIG. 3 shows an example illustrating the meanings of an expected zone and a request zone for the destination node in a network space, when using the LAR protocol.

In FIG. 3, the expected zone 310 means the possible location of the destination node. The request zone 320 is the minimum rectangle that consists of the expected zone and the source node. Radius R equals to v×Δt, where v is the average speed of the destination node, and Δt is the time elapsed since the last known location of the destination node.

When a node receives a route discovery message, it disseminates the route discovery message only when it is situated inside the request zone. Nodes outside the request zone that receive the route discovery message simply discard the message. Nodes inside the request zone have a better chance of successfully disseminating the route discovery message than those outside the zone. With this restriction, the overall amount of route discovery messages is reduced significantly.

### SUMMARY OF THE INVENTION

The exemplary embodiments according to the present invention may provide a communication routing apparatus and method via navigation system.

In an exemplary embodiment of the present invention, the disclosed is directed to a communication routing apparatus, applicable to a mobile network. The apparatus comprises a navigation module and a routing protocol mechanism. The navigation module may include map information and a navigation path calculation unit. The routing protocol mechanism inputs the location information of a source and a destination to the navigation path calculating unit. Through the map information, the navigation path calculating unit suggests a communication route between the mobile nodes from the source to the destination. With the help of the communication route, the routing protocol mechanism handles at least a route discovery message, at least a route reply message and at least a route error message from the source to the destination.

In another exemplary embodiment of the present invention, the disclosed is directed to a communication routing method, applicable to a mobile network. The communication routing method comprises: providing a navigation module, and the navigation module having map information therein; inputting location information of a source and location information of a destination to the navigation module; suggesting an inter-node communication route from the source to the destination; and handling at least a route discovery message, at least a route reply message, and at least a route error message from the source to the destination.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view illustrating how a route discovery message is disseminated in the DSR protocol.

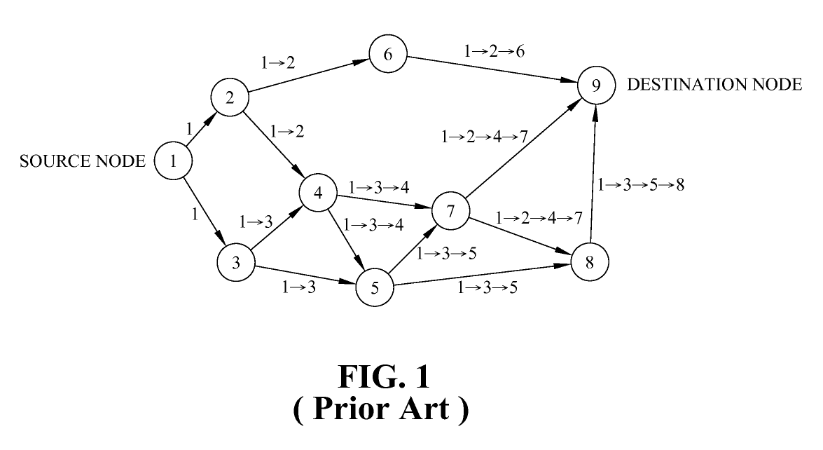

FIG. 2 shows an exemplary schematic view illustrating how a route reply message is disseminated in the DSR protocol.

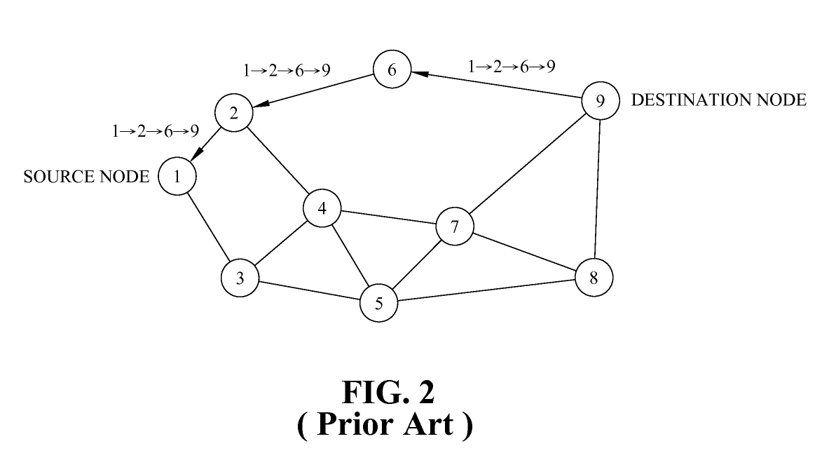

FIG. 3 shows an example illustrating the meanings of an expected zone and a request zone for the destination node in a network space, when using the LAR protocol.

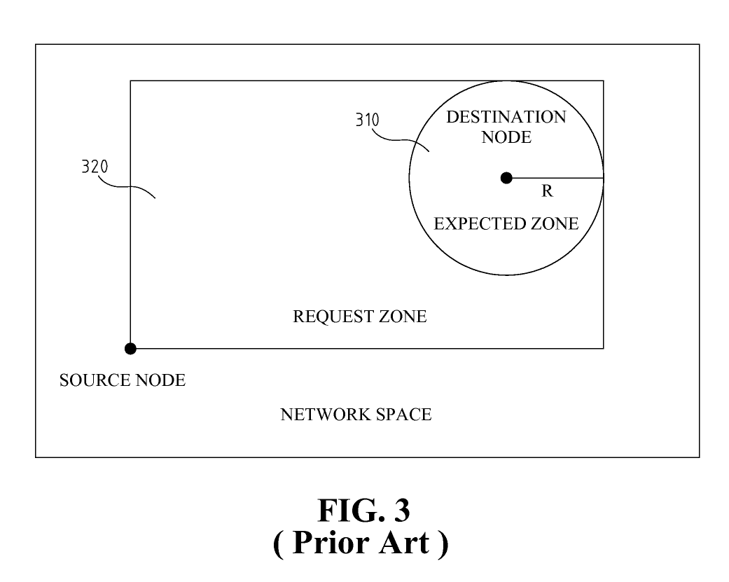

FIG. 4 shows a schematic view of an exemplary communication routing apparatus via navigation system, consistent with certain disclosed embodiments of the present invention.

FIG. 5A shows an exemplary schematic view for the weighted shortest path algorithm.

FIG. 5B shows an exemplary schematic view for the major road first algorithm.

FIG. 6 shows an example on how to handle the route discovery message under the first mode, consistent with certain disclosed embodiments of the present invention.

FIG. 7 shows an exemplary flowchart, illustrating a communication routing method via navigation system, consistent with certain disclosed embodiments of the present invention.

### DETAILED DESCRIPTION OF THE PREFERRED EMBODIMENTS

The present invention takes advantage of the map information and navigation system to find out inter-node communication routes. The exemplary disclosed embodiments of the present invention may provide a communication routing mechanism via navigation system. This communication routing mechanism at least includes the processing of route discovery messages, route reply messages, route error messages, and so on.

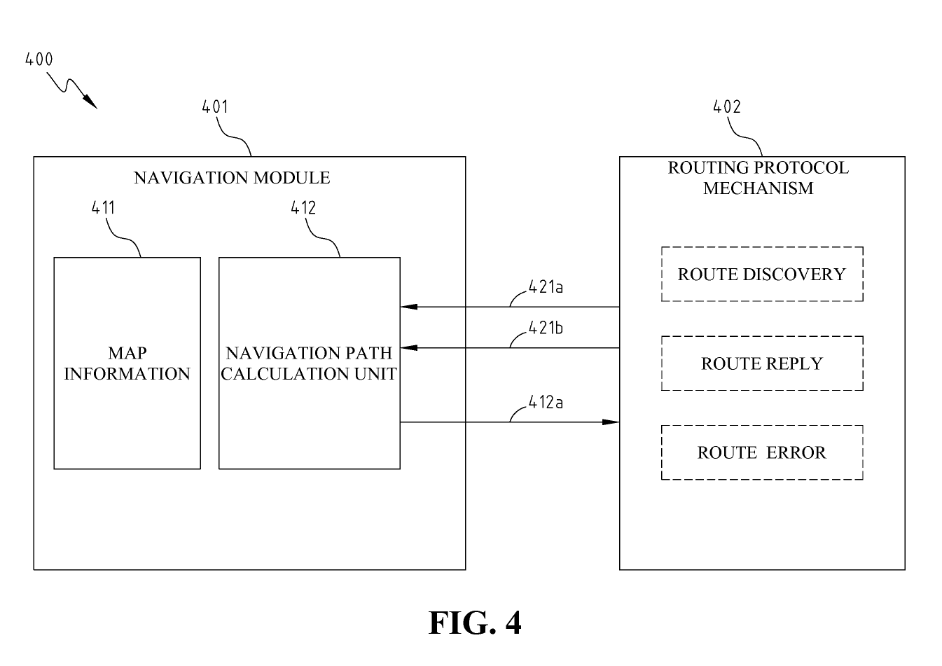

FIG. 4 shows a schematic view of an exemplary communication routing apparatus via navigation system, consistent with certain disclosed embodiments of the present invention. Referring to FIG. 4, the communication routing apparatus 400 comprises a navigation module 401 and a routing protocol mechanism 402. The navigation module 401 may include map information 411 and a navigation path calculation unit 412.

Map information 411 may include data, such as information of road section. The routing protocol mechanism 402 inputs the location information of a source 421a and the location information of a destination 421b to the navigation path calculating unit. Through the map information 411, for example road section, the navigation path calculating unit 412 suggests a communication route 412a, such as a message travel path or a corresponding road section list, between the mobile nodes from the source to the destination. With the help of the communication route 412a, the routing protocol mechanism 402 handles the route discovery message, the route reply message and the route error message from the source to the destination.

A message travel path is defined as the calculated path through navigation module 401 from the location of the source to that of the destination. The calculated path may be different, which may depend on how the source and the destination are moving. Modern navigation devices may have built-in algorithms for determining the navigation path. Typically, the calculated path by the navigation module is utilized in vehicle's moving paths, while the disclosed embodiments of the present invention utilize the calculated path as a message travel path. The navigation module will also consider the shortest path as the message travel path. This will be more beneficial for message delivery.

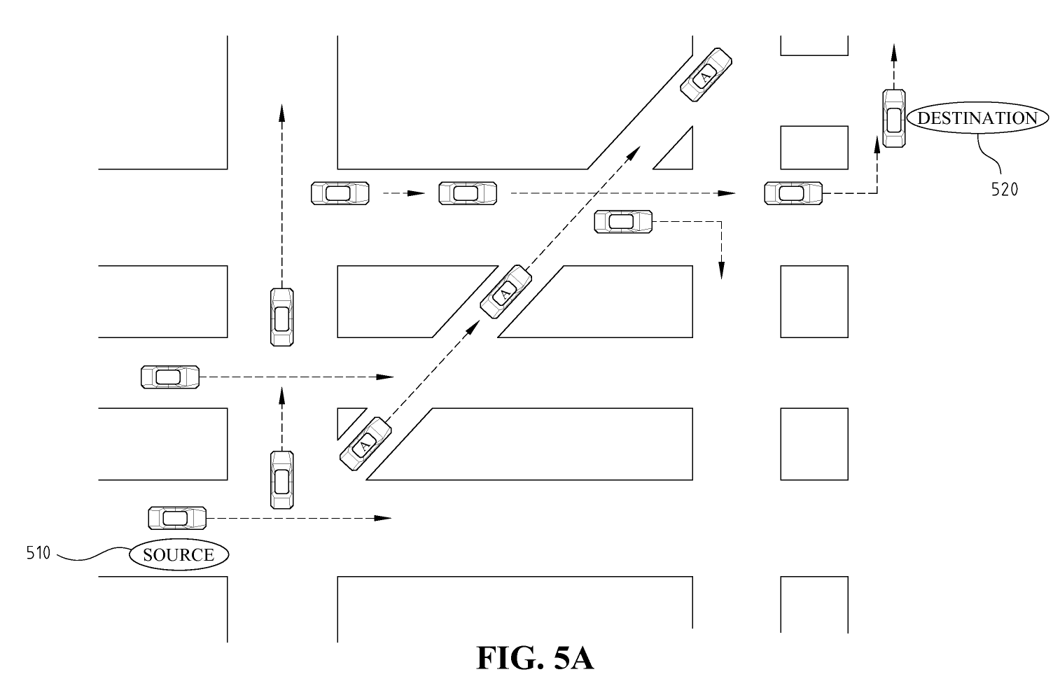

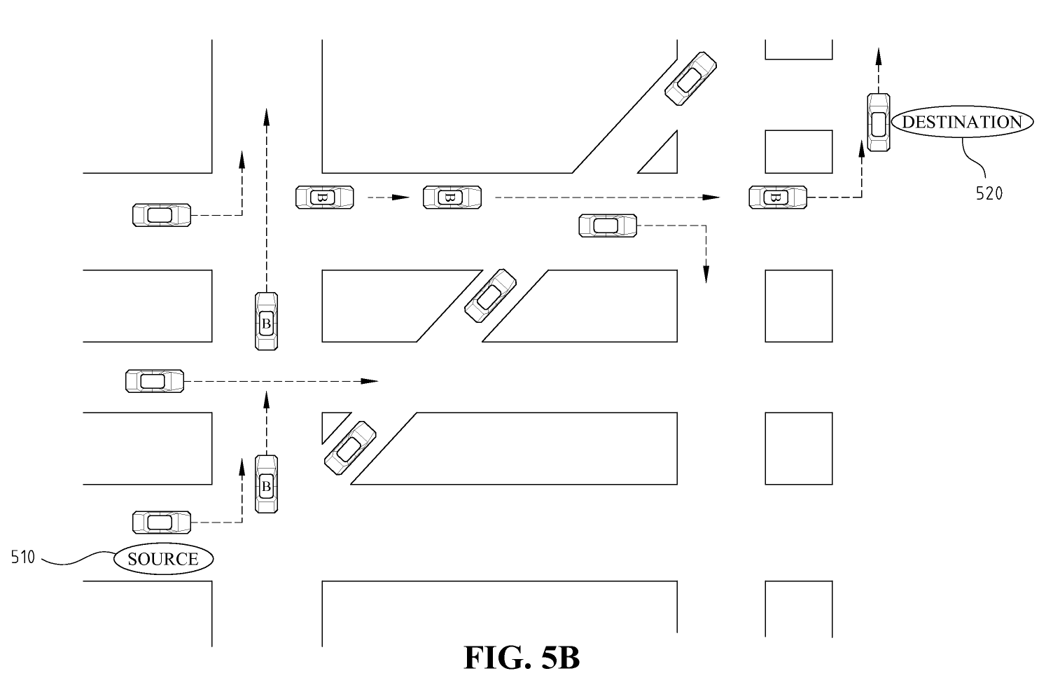

Such algorithms may be weighted shortest path algorithm, or the algorithm with main or larger roads having higher weights. Take a map as an example, FIG. 5A shows an exemplary schematic view for the weighted shortest path algorithm. The message travel path of the moving vehicles with mark A is the shortest path among the plurality of paths from the source 510 toward to the destination 520. With the same map, FIG. 5B shows an exemplary schematic view for the major road first algorithm. The travel path of the moving vehicles with mark B is the selected path among the plurality of paths from the source 510 toward to the destination 520, in which the moving vehicles with mark B are on the main roads.

Each road section in the map information 411 is given a unique road section identity. A road section list, for example, may consist of an ordered list of road section identities from a source to a destination.

Like LAR, it may assume the location of the destination at a previous time is known in the disclosed exemplary embodiment. When the source tries to contact the destination for the first time while the location of the destination is not known in advance, the disclosed embodiments may retrieve the location by flooding the route discovery message like DSR.

Since the location information is automatically adjusted in the navigation module 401 due to the fact that vehicle may only travel on road sections, the location deviation problem thus may be minimized.

The message travel path may help the LAR algorithm calculate the expected and request zones more precisely.

As mentioned before, the present invention may find out an inter-node communication route from a source to a destination through navigation information and routing information. In the exemplary disclosed embodiments, the routing protocol mechanism 402 may provide two modes for handling the route discovery message, route reply message and route error message from the source to the destination.

Under the first mode, when a source node needs to send a route discovery message to a reference coordinates known destination node. It first calculates an inter-node communication route and adds the route information as part of a route discovery message. When a node receives the route discovery message, it first checks the routing information within the route discovery message. If the node is not on the routing path, the route discovery message is discarded. If the node is on the routing path, it will help in disseminating the route discovery message.

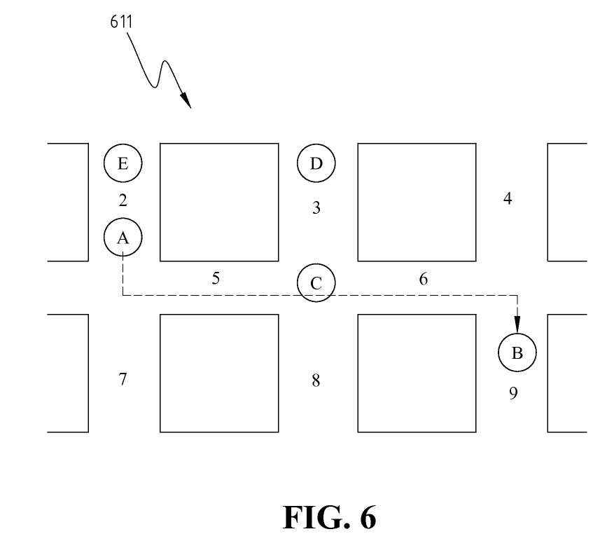

FIG. 6 shows an example on how to handle the route discovery message under the first mode, consistent with certain disclosed embodiments of the present invention. In the exemplary map information 611, there are 8 road sections with road section identities 2-9, respectively. The message travel path from the source node A to the destination node B may be denoted as the road section list 2→5→6→9. As may be seen from FIG. 6, node C is on the message travel path, while node D and node E are not. Upon receiving the route discovery message initiated by node A, node C will forward the message, while node D and E simply drop the message. The discarding mechanism of the route discovery message may significantly reduce the quantity of route discovery messages.

If the routing path cannot be found for a period of time, the source may send the route discovery message again. By flooding the route discovery message to the entire network, it may find a possible communication route according to the first mode.

The information included in the route discovery message may be the navigation information and the routing information. An example for the navigation information in the route discovery message may include source position, destination position, and road section list. An example for the routing information in the route discovery message may include current reference source coordinate, current reference destination coordinate, route discovery identity, and address list.

Under the second mode, when the source needs to send a route discovery message to a reference coordinates known destination, it sends a route discovery message out. This route discovery message may include the current coordinate of the source and the current coordinate of the destination and some optional parameters. The optional parameters may include source preferred route calculation algorithms, route calculation parameters such as the information of main roads.

When a node receives a route discovery message, it checks the current coordinate of the destination and those parameters. It also checks the map information built into this node. Through the map information, the node may check whether it satisfies the parameters set by the source or not. If the node does not satisfy these parameters, the route discovery message is discarded; otherwise the route discovery message is forwarded.

One example is that the source may prefer the intermediate nodes on the main roads, which may have more vehicles, and the receiving node is in a small lane. The receiving node does not satisfy the parameters set by the source node. Therefore, the receiving node simply discards the route discovery message. Another example is that the receiving node may be on an outer circular road physically closer to the destination, but it is not on a main road. Because the receiving node does not satisfy the parameters set by the source node, it also discards the route discovery message and disseminating the route discovery message is no longer proceeded.

At least the current reference coordinates of the source and destination are required in the route discovery message for both modes. Other parameters may help the exemplary disclosed embodiments of the present invention work better but they are not mandatory.

Handling the route reply message may be same as DSR. For example, the route reply message may include source address, destination address and address list.

Normally in an on demand routing protocol such as DSR, a node has to wait a timeout period to discover the route is broken. In the exemplary disclosed embodiments of the present invention, a route error message is sent right away by a mobile node. The route error message is part of the established route path, which is sent out of an inter-node communication route (under first mode) or a message travel path no longer satisfying parameters set by the source node (under second mode). Therefore, the source node may quickly learn of the route failure, and reinitiate the route discovery procedure. The error route message, for example, may include source address, destination address and error address list.

In the exemplary disclosed embodiments of the present invention, the algorithm of determining the message travel path assumes that the destination coordinates are known. The present invention also mentions that the destination coordinates may be queried by flooding when it is unknown. The reference coordinates of the destination may also be learned through picking up caching message proxy forwarded by the source. In other words, the reference coordinates of the destination are not obtained through ad-hoc algorithm.

In the exemplary disclosed embodiments of the present invention, it may be seen from the handling under the first mode or the second mode that the inter-node communication route may be presented by road ID or road section ID, or reference coordinates used by GPS.

The calculation of inter-node communication route may also include current traffic conditions of neighbor regions. This information may be obtained through an external Traffic Information System.

The parameters included in the route discovery message under first mode may include source coordinates, destination coordinates, allowed location error due to the intrinsic inaccuracy of navigation module, and suggested message travel path from source to destination. The suggested message travel path is provided for other nodes to decide if they wanted to participate in disseminating the route discovery message.

The parameters included in the route discovery message under second mode may include source coordinates, destination coordinates, preferred algorithm for message travel path, forbidden areas, and current vector value. This current vector value shows that the receiving node's distance to the destination provided that all parameters are satisfied.

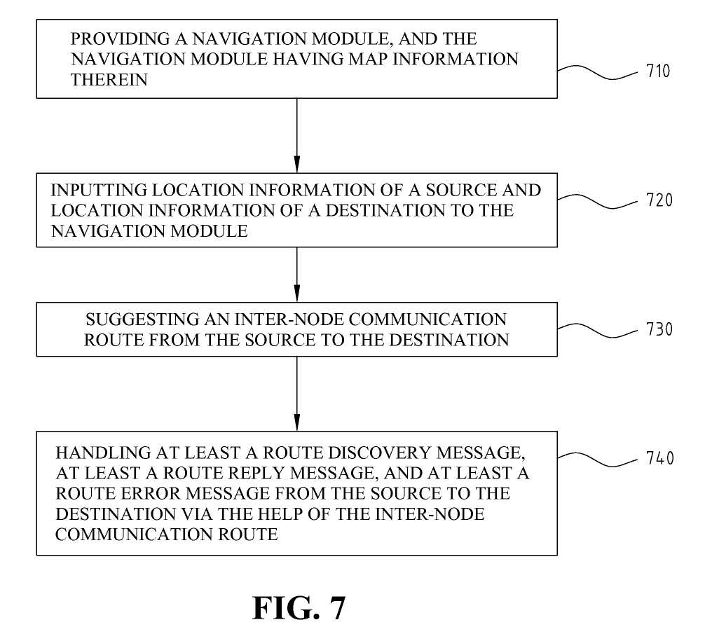

From the above description, FIG. 7 shows an exemplary flowchart, illustrating a communication routing method via navigation system, consistent with certain disclosed embodiments of the present invention. The communication routing method at least includes: providing a navigation module, and the navigation module having map information therein (step 710); inputting location information of a source and location information of a destination to the navigation module (step 720); suggesting an inter-node communication route from the source to the destination (step 730); and handling at least a route discovery message, at least a route reply message, and at least a route error message from the source to the destination (step 740).

With the help of the inter-node communication route, how to handle the at least a route discovery message, the at least a route reply message, and the at least a route error message from the source to the destination is same as the handling of both modes provided by the routing protocol mechanism 402. Therefore, no further details described thereof are provided.

In summary, the exemplary disclosed embodiments may provide a communication routing apparatus and method via navigation system. The communication routing mechanism utilizes map information and navigation information to find out a inter-node communication route. The discarding mechanism of the route discovery message may significantly reduce the quantity of route discovery messages. The route error message may be sent right away by a mobile node.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A communication routing apparatus, applicable to a mobile network, said apparatus comprising:
a navigation module having map information and a navigation path calculation unit therein; and
a routing protocol mechanism that inputs the location information of a source and a destination to said navigation path calculating unit;
wherein said navigation path calculating unit suggests a communication route between the mobile nodes on said mobile network from said source to said destination through said map information, and said routing protocol mechanism handles at least a route discovery message, at least a route reply message and at least a route error message from said source to said destination via the help of said communication route.

2. The apparatus as claimed in claim 1, wherein said communication route is presented by either road identity/road section identity or reference coordinates used by navigation systems.

3. The apparatus as claimed in claim 1, wherein said communication route is a message travel path consisting of an ordered list of road section identities from said source to said destination.

4. The apparatus as claimed in claim 1, wherein said map information at least includes a plurality of road section identities, each of said road section identity is given a unique road section identity.

5. The apparatus as claimed in claim 1, wherein said routing protocol mechanism provides a first mode and a second mode to handle said at least a route discovery message, said at least a route reply message and said at least a route error message from said source to said destination.

6. The apparatus as claimed in claim 1, wherein said at least a route discovery message consists of navigation information and routing information.

7. The apparatus as claimed in claim 5, wherein when a node receives one of said at least route discovery message from said source, if the node is not on the path of said communication route under said first mode, the route discovery message is discarded.

8. The apparatus as claimed in claim 7, wherein if the node is on the path of said communication route, it helps in disseminating the route discovery message.

9. The apparatus as claimed in claim 5, wherein when a node receives one of said at least route discovery message from said source, if the node satisfies the parameters set by said source under said second mode, it helps in disseminating the route discovery message.

10. The apparatus as claimed in claim 9, wherein if the node does not satisfy the parameters set by said source, the route discovery message is discarded.

11. The apparatus as claimed in claim 1, wherein each of said at least a route discovery message at least includes the reference coordinates of said source and said destination.

12. A communication routing method, applicable to a mobile network, said method comprising:
providing a navigation module, and said navigation module having map information therein;
inputting location information of a source and location information of a destination to said navigation module;
suggesting an inter-node communication route from said source to said destination; and
handling at least a route discovery message, at least a route reply message and at least a route error message from said source to said destination via the help of said inter-node communication route.

13. The method as claimed in claim 12, said method provides a first mode and a second mode to handle said at least a route discovery message, said at least a route reply message and said at least a route error message from said source to said destination.

14. The method as claimed in claim 13, wherein said handling at least a route discovery message from said source to said destination under said first mode further includes:
when said source needs to send a route discovery message to said destination node, it calculates an inter-node communication route and adds the route information as part of the route discovery message;
when a node receives the route discovery message, it first checks the routing information within the route discovery message; and
if the node is on the routing path, it helps in disseminating the route discovery message, otherwise, the route discovery message is discarded.

15. The method as claimed in claim 13, wherein said handling at least a route discovery message from said source to said destination under said second mode further includes:
when said source needs to send a route discovery message to said destination, it sends a route discovery message out, said route discovery message at least include the current coordinates of said destination and at least a parameter set by said source;
when a node receives a route discovery message, whether or not the node satisfies the at least a parameter set by said source is checked; and
if the node satisfies the at least a parameter, the route discovery message is forwarded, otherwise, the route discovery message is discarded.

16. The method as claimed in claim 13, wherein each of said at least a route discovery message at least includes the reference coordinates of said source and said destination.

17. The method as claimed in claim 16, wherein each of said at least a route discovery message under said first mode further includes allowed location error due to the intrinsic inaccuracy of a navigation module, or a suggested message travel path from said source to said destination, or both.

18. The method as claimed in claim 16, wherein each of said at least a route discovery message under said second mode further includes the messages chosen from a preferred algorithm for calculating a message travel path, forbidden areas and a current vector value.

19. The method as claimed in claim 13, wherein under said first mode, each of said at least a route error message is sent right away by a mobile node on said inter-node communication route, which allows said source node quickly learns of the route failure.

20. The method as claimed in claim 13, wherein under said second mode, each of said at least a route error message is sent right away by a mobile node being on a message travel path and no longer satisfying said at least a parameter set by said source, which allows said source node quickly learns of the route failure.
